(19) United States
(12) Patent Application Publication
(10) Pub. No.: US 2006/0004724 A1
(43) Pub. Date: Jan. 5, 2006

(54) Information-processing system, information-processing method and information-processing program

(75) Inventors: Satoshi Tabata, Tokyo (JP); Hiroyuki Hatanaka, Saitama (JP); Masaki Matsudaira, Kanagawa (JP); Yukihiro Morita, Saitama (JP); Masayoshi Matsushita, Chiba (JP)

Correspondence Address: VENABLE LLP, P.O. BOX 34385, WASHINGTON, DC, 20045-9998, US

(73) Assignee: Oki Electric Industry Co., Ltd., Minato-ku (JP)

(21) Appl. No.: 11/142,911

(22) Filed: Jun. 2, 2005

(30) Foreign Application Priority Data
Jun. 3, 2004 (JP) JP2004-166258

(51) Int. Cl. G06F 17/30

(52) U.S. Cl. 707/3

(57) ABSTRACT

An information-processing system includes a phrase category processing unit, a first hypertext document generating unit, a first correlation management unit, a second correlation management unit that manages a correlation between one or a plurality of action categories and the locations of application function units and a selection accepting unit. As a user specifies a phrase in a first hypertext document, the first correlation management unit is engaged to search for an action category corresponding to the phrase category of the phrase. As the user selects an action by using a dialogue component in a second hypertext document provided by the selection accepting unit, the application function unit corresponding to the action category of the action is started up by engaging the second correlation management unit to search for the location of the application function unit.

### CROSS-REFERENCE TO RELATED APPLICATIONS

The disclosure of Japanese patent application No. JP 2004-166258 filed on Jun. 3, 2004, entitled “Information-processing System, Information-processing Method and Information-processing Program”. The contents of that application are incorporated herein by reference in their entirety.

### BACKGROUND OF THE INVENTION

1. Field of the Invention

The present invention relates to an information-processing system, an information-processing method and an information-processing program that may be adopted in an ideal manner to achieve highly efficient linkage among a plurality of applications as intended by the user.

2. Description of the Related Art

The technologies related to natural language processing in the related art include non-patent reference literature 1 and patent reference literature 1 below.

Non-patent reference literature 1; Junichi Fukumoto et al. “Comparison of Japanese Language and English Language With Regard to Proper Noun Extraction”, Shingaku Giho, NLC 98-21, 1998, p. 45-52 Patent reference literature 1: Japanese Laid Open Patent Publication No. 2003-256444

The technology disclosed in non-patent reference literature 1 enables extraction of proper nouns such as the names of persons, organizations and places in a document.

Patent reference literature 1 discloses that a single semantic concept or a plurality of semantic concepts are correlated to each word in a thesaurus and a plurality of filing categories are correlated to each semantic concept in a thesaurus-filing category correspondence table. As a search keyword is input, a semantic concept corresponding to the search keyword is identified by using the thesaurus and then the filing categories corresponding to the semantic concept are determined in reference to the thesaurus-filing category correspondence table.

Next, the results of the search based upon the search keyword, executed by a standard search engine or the like, are sorted in correspondence to the individual filing categories in conformance to specific filing category decision-making rules.

Thus, the user having entered the search keyword obtains an answer sorted with a degree of precision corresponding to the filing categories.

By adopting the technology disclosed in non-patent reference literature 1 and the technology disclosed in patent reference literature 1 in conjunction with each other, the following might be possible.

Namely, a proper noun (the name of a person, an organization, a place, a product or the like) in a document sent by electronic mail, posted on the Web, handled by a document preparation tool or handled in a business application is extracted through the technology disclosed in non-patent reference literature 1 and then the results of a search executed by using the proper noun as a search keyword can be sorted and output in correspondence to filing categories through the technology disclosed in patent reference literature 1.

However, from the user's point of view, the combination of these technologies simply allows him to receive the results of the search (sorted in correspondence to the individual filing categories) executed in response to the entry of the search keyword and if he wishes to take any action in relation to the search keyword or the received search results (e.g., transmitting an electronic mail, verifying his schedule in a scheduler or making a phone call), the user will have to start up a relevant application by operating a personal computer or the like as in the related art, and the whole process can be time-consuming and impose a significant operational onus to result in poorer work efficiency.

### SUMMARY OF THE INVENTION

The problem discussed above can be solved in a first aspect of the present invention disclosing an information-processing system that enables a user to start up a plurality of types of application function units each having one function or a plurality of functions (e.g., a mailer, an telephone software, and a map information service) to allow the user to achieve specific purposes, comprising a phrase category processing unit that extracts one or a plurality of phrases (e.g., a keyword) from a target document in response to an instruction issued by the user, identifies a specific phrase category (e.g., a person's name, an organization name or a technical term) of each extracted phrase and then correlates the phrase with the phrase category, a first hypertext document generating unit that generates a first hypertext document (e.g., a keyword selection page DC11) having a link attached to each phrase based upon the correlation between the phrase and the phrase category, a first correlation management unit that manages a correlation between the phrase category and a single action category of an action or a plurality of action categories of actions to be taken by the user in correspondence to the phrase category, a second correlation management unit that manages a correlation between the single action category or the plurality of action categories and the locations of the application function units and a selection accepting unit that generates a second hypertext document having a single dialogue component or a plurality of dialogue components (e.g., buttons BT1 to BT5) corresponding to the single action category or the plurality of action categories each listed as a link connection of a link assigned to a phrase in the first hypertext document provides the user with the second hypertext document and accepts an action selection made by the user. The information-processing system is characterized in that when the user specifies a phrase in the first hypertext document, the information-processing system engages the first correlation management unit to search for the action categories corresponding to the phrase category of the phrase and that when the user selects a specific action by selecting a dialog component in the second hypertext document provided by the selection accepting unit, the information-processing system starts up an application function unit corresponding to the action category of the action by engaging the second correlation management unit to search for the location of the application function unit.

In this specification, the word “phrase (s)” includes the meaning of phrase(s) and word(s).

A second aspect of the present invention provides an information-processing method that allows a plurality of types of application function units to be started up with each application function unit having one function or a plurality of functions to enable a user to achieve a specific purpose in which a phrase category processing unit extracts one or a plurality of phrases from a target document in response to an instruction issued by the user, identifies a specific phrase category of each extracted phrase and then correlates the phrase with the phrase category, a first hypertext document generating unit generates a first hypertext document having a link attached to each phrase based upon the correlation between the phrase and the phrase category, a first correlation management unit manages a correlation between the phrase category and a single action category of an action or a plurality of action categories of actions to be taken by the user in correspondence to the phrase category, a second correlation management unit manages a correlation between the single action category or the plurality of action categories and the locations of the application function units and a selection accepting unit generates a second hypertext document having a single dialogue component or a plurality of dialogue components corresponding to the single action category or the plurality of action categories each listed as a link connection of a link assigned to a phrase in the first hypertext document, provides the user with the second hypertext document and accepts an action selection made by the user. The information-processing system is characterized in that when the user specifies a phrase in the first hypertext document, the first correlation management unit is engaged to search for the action categories corresponding to the phrase category of the phrase and that when the user selects a specific action by selecting a dialog component in the second hypertext document provided by the selection accepting unit, an application function unit corresponding to the action is started up by engaging the second correlation management unit to search for the location of the application function unit.

A third aspect of the present invention provides an information-processing program that allows a plurality of types of application function groups to be started up with each application function group having one or a plurality of functions to enable a user to achieve specific purposes, realizing in a computer a phrase category processing function for extracting one or a plurality of phrases from a target document in response to an instruction issued by the user, identifying a phrase category of each extracted phrase and correlating the phrase with the phrase category, a first hypertext document generating function for generating a first hypertext document having a link assigned to each phrase based upon the correlation between the phrase and the phrase category, a first correlation management function for managing a correlation between the phrase category and a single action category of an action or a plurality of action categories of actions to be taken by the user in correspondence to the phrase category, a second correlation management function for managing a correlation between a single action category or the plurality of action categories and the locations of the relevant application function groups and a selection accepting function for generating a second hypertext document having one or a plurality of dialogue components corresponding to the a single action category or the plurality of action categories each listed as a link connection of a link assigned to a phrase in the first hypertext document, providing the user with the second hypertext document and accepting an action selection made by the user. The information-processing program is characterized in that when the user specifies a phrase in the first hypertext document, the first correlation management function is engaged to search for the action categories corresponding to the phrase category of the phrase and that when the user selects a specific action by selecting a dialog component in the second hypertext document provided through the selection accepting function, an application function group corresponding to the action category of the action by engaging the second correlation management function to search for the location of the application function group.

The present invention improves the work efficiency.

### BRIEF DESCRIPTION OF THE DRAWINGS

FIG. 1 is a schematic diagram showing the overall structure adopted in the communication system achieved in an embodiment;

FIG. 2 presents a flowchart of the operation executed in the embodiment;

FIG. 3 schematically shows how the screen display may shift at the client apparatus constituting part of the communication system in the embodiment;

FIG. 4 schematically shows how the screen display may shift at the client apparatus constituting part of the communication system in the embodiment;

FIG. 5 schematically shows how the screen display may shift at the client apparatus constituting part of the communication system in the embodiment;

FIG. 6 schematically shows how the screen display may shift at the client apparatus constituting part of the communication system in the embodiment;

FIG. 7 schematically shows an example of a screen display that may be brought up at the client apparatus constituting part of the communication system in the embodiment;

FIG. 8 schematically shows an example of a screen display that may be brought up at the client apparatus constituting part of the communication system in the embodiment;

FIG. 9 schematically shows examples of the structures that may be adopted in the tables used in the communication system in the embodiment;

FIG. 10 schematically shows examples of structures that may be adopted in the tables used in the communication system in the embodiment and examples of values that may be taken in the tables;

FIG. 11 schematically shows an example of a structure that may be adopted in a table used in the communication system in the embodiment; and

FIG. 12 schematically shows an example of a structure that may be adopted in a table used in the communication system in the embodiment and examples of values that may be taken in the table.

### DETAILED DESCRIPTION OF THE PREFERRED EMBODIMENTS

### Embodiment

The following is an explanation of an embodiment of the information-processing system, the information-processing method and the information-processing program according to the present invention.

(A-1) Structure Adopted in the Embodiment

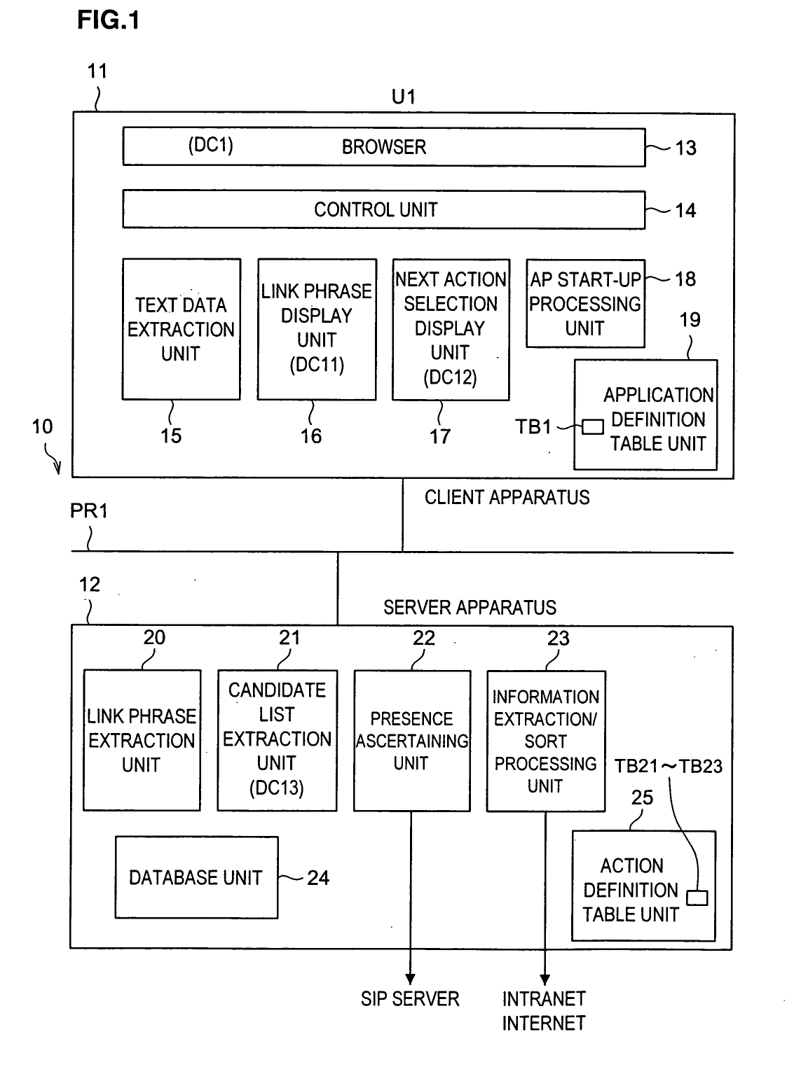

FIG. 1 shows an example of an overall structure that may be adopted in a communication system 10 achieved in the embodiment.

The communication system 10 in FIG. 1 includes a client apparatus 11, a server apparatus 12 and a transmission line PR 1 connecting the client apparatus and the server apparatus to each other.

The client apparatus 11 is a communication apparatus used by a user U1, which comprises a browser 13, a control unit 14, a text data extraction unit 15, a link phrase display unit 16, a next action selection display unit 17, an AP startup-processing unit 18 and an application definition table unit 19.

While the client apparatus 11 may be constituted with a personal computer or the like with a networking function, it may instead be constituted with a portable information terminal or the like as necessary.

The browser 13 is used by the user U1 when he browses information. While a software program that enables the user to browse information is normally referred to as a browser, the browser 13 in the embodiment may be a web browser having a function that allows the user to browse web pages. A standard web browser product comes loaded with diverse auxiliary functions in addition to the essential information browsing function, and the browser 13, too, may have such auxiliary functions as needed.

A hardware equivalent of the control unit 14 may be, for instance, the CPU (central processing unit) in the client apparatus 11, and a software equivalent of the control unit 14 may be, for instance, the OS (operating system).

While the other components 15 through 19 in the client apparatus 11 may be included as auxiliary functions of the browser 13, there are mounted outside the browser 13 in the example presented in the figure.

Among the components 15 through 19, the text data extraction unit 15 has a function of extracting text data from a document DC1 in response to a specific operation performed by the user U1 while browsing the document DC1 by using the browser 13. In the text data extraction, text (character string) data alone are extracted from a web page or the like by excluding information (HTML tags or the like) that defines the logic structure and the display structure. Since there are readily available web browser products that enable such text data extraction through a simple button operation of the known art, the text data extraction function can be realized with great ease.

For instance, a specific phrase extraction button may be brought up on the browser screen and an instruction for the text data extraction unit 15 to extract the text data in the web page being browsed may be issued simply as the user U1 clicks the phrase extraction button.

While any document can be browsed by using the browser 13, an explanation is given on an example in which the document DC 1 is browsed. The document DC1 may be a web page.

The link phrase display unit 16 has a function of having a keyword selection page DC 11 with one or a plurality of candidate keywords (link phrases) laid-out in a click-enabling format brought up on display by the browser 13. For instance, as the user U1 moves the mouse cursor onto a desired candidate keyword in the keyword selection page DC 11 and clicks it, a request message can be transmitted to an URL (link connection) correlated with the keyword by using an “a” tag among the HTML tags.

The keyword selection page DC 11 is generated by a link phrase extraction unit 20 in the server apparatus 12 based upon the text data extracted from the document DC 1 by the text data extraction unit 15 and is then transmitted to the client apparatus 11. While any phrases may be used as candidate keywords, the keyword selection page DC 11 may be structured so as to include keyword attributes of proper nouns such as people's names, organization names, location names, product names, technology names and telephone numbers by adopting the technology disclosed in non-patent reference literature 1 described earlier.

For instance, by entering the following descriptor code (SC1) as the attribute of the start tag of the “a” tag in the keyword selection page DC 11, which is an HTML file, the request message mentioned above can be transmitted.
<a href=http://intra.aaa.com/service/getinfo?key=X+category=Y> . . . (SC1)

In this descriptor code (SC1), X entered after “key=”, indicates the selected keyword, and Y entered after “category=” indicates the keyword attribute (e.g., the keyword attribute ascertained by adopting the technology disclosed in non-patent reference literature 1 described earlier) of the keyword. Accordingly, the keyword selected by the user U1 and the attribute of the selected keyword can be communicated to the server apparatus 11 through the request message. The request message is received by an information extraction/organizing unit 23 at the server apparatus 12.

The next action selection display unit 17 has a function of having dialogue components brought up on display by the browser 13 to allow the user U1 to select the next action he wishes to take. While the dialogue components may assume any of various modes, they may be realized as buttons indicating various actions that are brought up on display in a browser screen displayed by the browser 13 so as to allow the user U1 to select a specific action by clicking one of the buttons. The page having these buttons displayed therein, which is browsed by the user U1 with the browser 13 when selecting the action, is referred to as a next action selection page DC 12. The next action selection page DC 12 is to be described in detail later.

The AP startup-processing unit 18 has a function of starting up an AP (application) corresponding to the action selected by the user U1 in the next action selection page DC 12. The application that is started up by the AP startup-processing unit may be a local application (e.g., a mailer enabling electronic mail exchange) installed in the client apparatus 11 or it may be a remote application such as a web application installed in a given web server.

The AP startup-processing unit 18 also has a function of handing over the value indicated by a relevant parameter to a local application at the time of or immediately after starting up the application. As a result, the user U1 no longer needs to enter the parameter value (e.g., the recipient's electronic mail address) in the application having been started up.

The application definition table unit 19 is a database having registered therein an application definition table TB1.

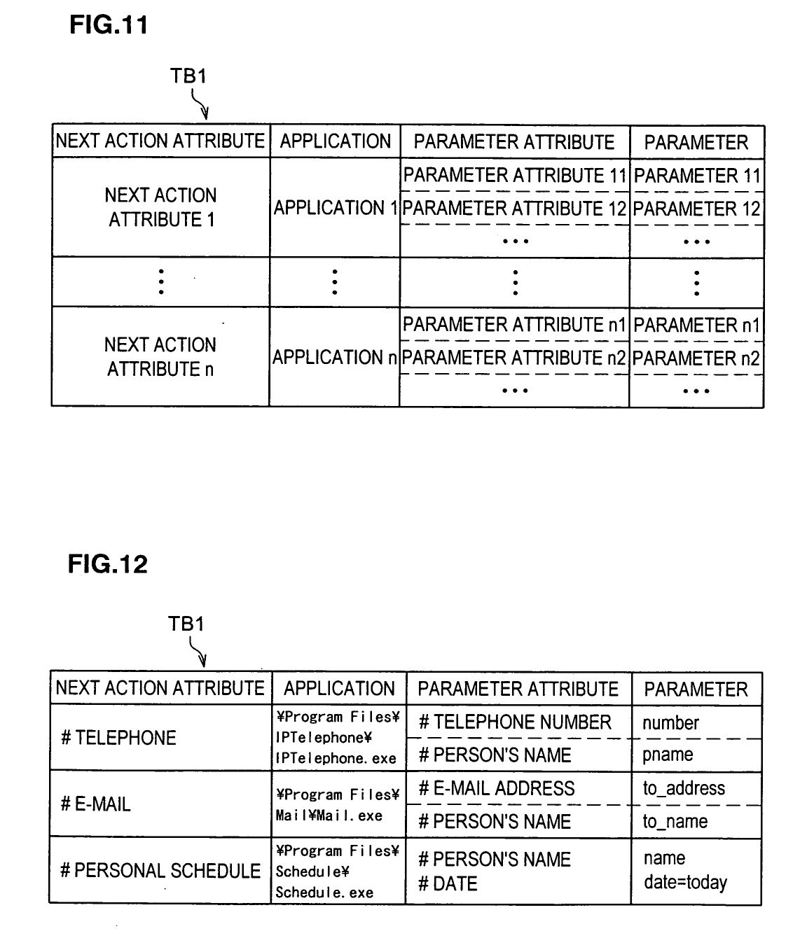

The application definition table TB1 may adopt a structure such as that shown in FIG. 11, for instance. FIG. 12 shows specific examples of values that may be indicated in correspondence to the various data entries in the table shown in FIG. 11.

The data categories in the application definition table TB1 in FIGS. 11 and 12 include “action attribute”, “application”, a “parameter attribute” and “parameter”.

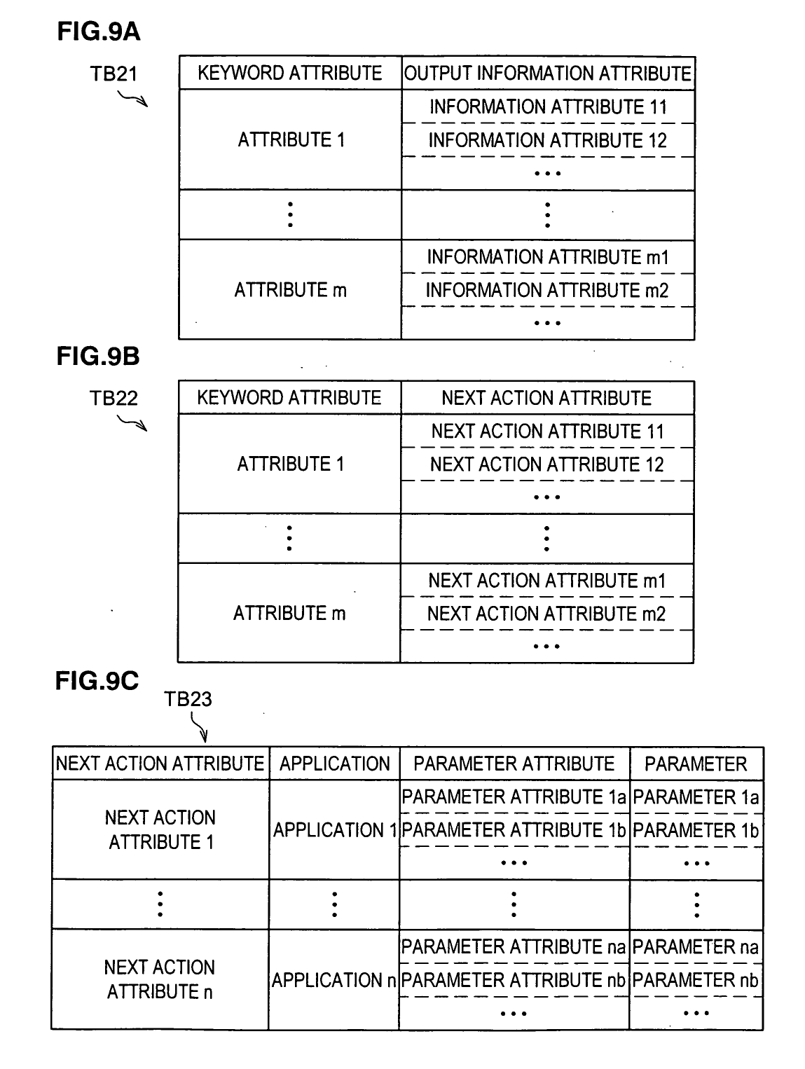

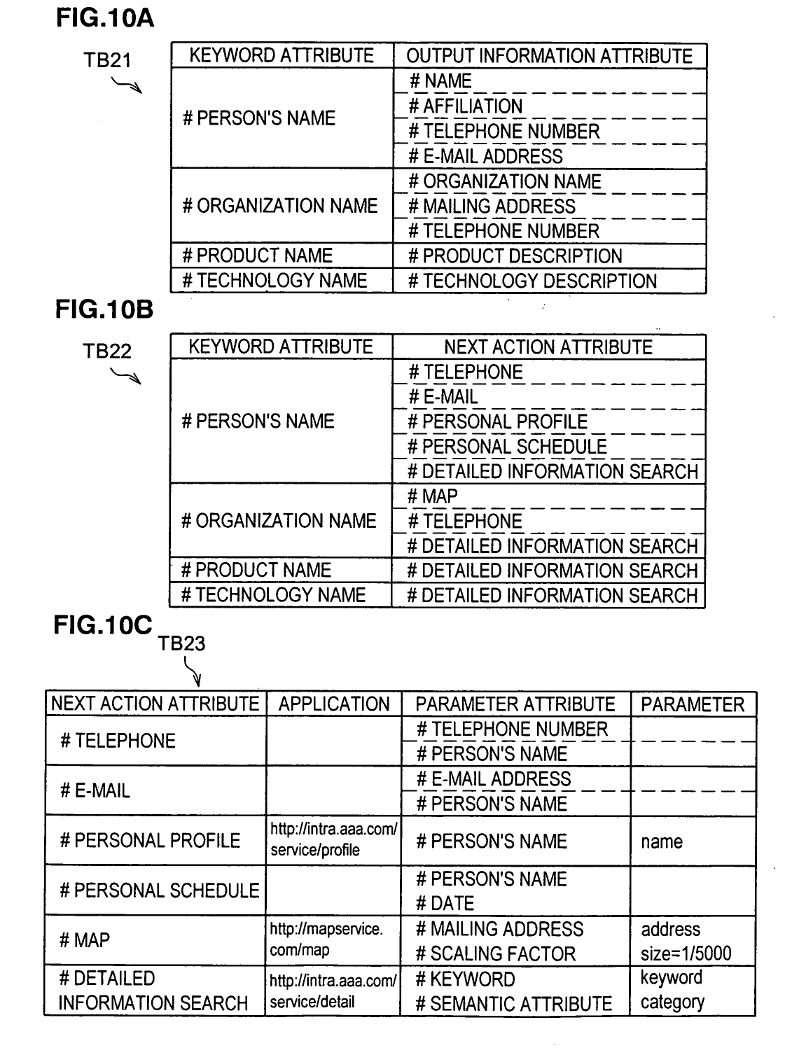

As the action attribute data, which correspond to the action attributes in FIGS. 9 and 10 to be detailed later, candidate actions that may be taken after the user U1 extracts the text data from the document DC 1 are registered.

As the application data, information related to local applications that may be started up by the AP startup-processing unit 18 is registered. In the example presented in FIG. 12, path names indicating the locations of the relevant local applications are registered as the application data. It is to be noted that actions and applications have a one-to-one correlation in the example presented in FIG. 12 although this is not strictly necessary.

As the parameter data, the names of the individual parameters are registered, whereas the parameter attributes of the individual parameters are registered as the parameter attribute data. “date=today” indicates that “today” is handed over to the application as the default value so as to check today's schedule when a date for the personal schedule check is not specified by the user.

Attributes of the applications (application attributes) may be defined instead of the parameter attributes in the table.

It is to be noted that in each pair of an upper parameter attribute and a lower parameter attribute or each pair of an upper parameter and a lower parameter separated from each other by “---” in the table TB1 in FIG. 12 (e.g., # telephone number and # person's name), the upper parameter attribute and the lower parameter attribute or the upper parameter and the lower parameter are alternative to each other (they have an OR relationship) i.e., only one of them can be specified, whereas an upper parameter attribute and a lower parameter attribute or an upper parameter and a lower parameter not separated from each other with “---” (e.g., # person's name and # date) have an AND relationship and both of them must be specified.

The server apparatus 12 comprises the link phrase extraction unit 20, a candidate list extraction unit 21, a presence-ascertaining unit 22, the information extraction/organizing unit 23, a database unit 24 and an action definition table unit 25.

The link phrase extraction unit 20 generates the keyword selection page DC 11 based upon the text having been extracted from the document DC1 and transmitted via the transmission line PR1.

The candidate list extraction unit 21 generates a candidate list page DC 13 which is a web page listing a plurality of candidates if a keyword (candidate keyword) selected by the user U1 in the keyword selection page DC 11 is a proper noun that cannot be univocally identified. While there are various types of proper nouns that may not be univocally identified, an explanation is given here by assuming that the user has selected a person's name as the keyword. Since the keyword indicating a person's name does not always enable a univocal identification of the actual person, further information is displayed in addition to the person's name in the candidate list page DC 13 to help the user U1 identify the correct person among the candidates. For instance, in an application in a corporate intranet or the like, the departments to which the candidates belong and the candidates' telephone numbers may be displayed together with the names so as to enable the user U1 to univocally specify the correct person in the candidate list page DC 13. In addition, if the keyword is constituted with a family name alone, the full names of the candidates may be displayed in the candidate list page DC 13 to enable a univocal identification of the correct person.

The presence-ascertaining unit 22 obtains presence information (the current posting statuses of the candidates) related to the candidates listed in the candidate list page DC 13. Such presence information may be obtained from, for instance, an SIP (session initiation protocol) server.

The information extraction/organizing unit 23 executes information gathering process for gathering information by using a service provided in an intranet or on the Internet (or by using the database unit 24 of the server apparatus 12 itself) and prepares a list of next actions in preparation for processing executed to generate the next action selection page DC 12 described earlier.

In addition to the person's name explained above, the possible keyword attributes include “organization name”, “product name” and “technology name”, as shown in the next action definition tables TB21 and TB22 in FIGS. 10(A) and 10(B). The next action selection page DC 12, which is a web page that enables the user U1 to select the next action to be taken with the browser 13, may assume the structure shown in FIG. 8, for instance. As the user U1 clicks one of the buttons BT1 to BT5 in FIG. 8, an appropriate action can be taken with regard to Mr. “Taro Yamada”. For instance, if he clicks the button BT1, he can make a phone call to Mr. Taro Yamada, whereas if he clicks the button BT3, he can check the personal profile of Mr. Taro Yamada.

In addition, Mr. Taro Yamada's telephone number “03-1234-5678” needed to call him up on the telephone will have been obtained through the information gathering process and, as a result, the user only needs to click the button BT1 to automatically hand over the telephone number to the software phone (IP telephone software program) installed in the client apparatus 11. Information indicating Mr. Yamada's name and the affiliated department to which he belongs, which is needed for the personal profile check, is automatically entered to the corresponding application simply by clicking the button BT3.

While the names of the next action attributes such as those shown in FIG. 10(C) are directly used on the buttons BT1 to BT6 to indicate the contents of the specific actions (e.g., “telephone” displayed over the button BT1), any action contents can be displayed freely beyond the constraints of specific attribute names by preparing in advance a special table for such purposes.

It is to be noted that the information gathering process may be executed by the information extraction/organizing unit 23 by adopting the technology disclosed in patent reference literature 1.

The action definition table unit 25 is a database having registered therein an action definition table constituted with three tables TB 21 to TB 23.

The tables TB 21 to TB 23 may adopt structures such as those shown in FIGS. 9(A) to 9(C) respectively. FIGS. 10(A) to 10(C) present examples of specific values that may be indicated in correspondence to the individual data entries in the tables shown in FIGS. 9(A) to 9(C) respectively.

The table TB 21 in FIGS. 9(A) and 10(A) contains data categorized as the “keyword attribute” described earlier and an “output information attribute”.

As the keyword attribute, the attributes of phrases selected as keywords are registered.

As the output information attribute data the attributes of a static type of output information among sets of information output to be displayed by the browser 13 (e.g., to be displayed in the next action selection page DC 12). For instance, character strings such as “name”, “affiliation” and “telephone number” in the next action selection page DC 12 in FIG. 8 each correspond to the value (attribute name) of an output information attribute.

The table TB 22 in FIGS. 9(B) and 10(B) contains data categorized as “keyword attribute” and “action attribute”.

The keyword attribute data in the table TB 22 are identical to the keyword attribute data in the table TB 21.

The action attribute data indicate the attributes of candidate actions that may be selected by the user U 1 next.

For instance, in correspondence to the keyword attribute “person's name”, phoning the person bearing the name, transmitting an electronic mail to the person, checking a personal profile of the person, checking a personal schedule related to the person and searching for more detailed information related to the person are listed as likely actions to be taken next in the table TB 22 in FIG. 10(B).

The table TB 23 in FIGS. 9(C) and 10(C) contains data categorized as “action attribute”, “application”, “parameter attribute” and “parameter”.

The action attribute data in the table TB 23 are identical to the action attribute data in the table TB 22.

The application data, the parameter attribute data and the parameter data are respectively identical to the application data, the parameter attribute data and the parameter entry in the table TB1 explained earlier in reference to FIGS. 11 and 12.

It is to be noted that there are application data and parameter data in the table TB 23 shown in FIG. 10(C), in correspondence to which no values are entered (no values are registered). If a given application (local application) is installed in the client apparatus 11 itself, the application value, i.e., the URL (web service command), is not entered, since it does not need to be registered in the table TB 23 at the server apparatus 12 as long as its location (path name) is registered in the table TB1 at the client apparatus 11. No value is entered for a parameter in the table TB 23 under similar circumstances. Processing for handing over the value of such a parameter to an application installed in the client apparatus 11 can be executed within the client apparatus 11 without directly involving the server apparatus 12.

In addition, “size= 1/5000” entered as a parameter value in FIG. 10(C) indicates that the default value set for the size (scaling factor) of the map provided through the map information service is 1/5000. If a map size is not specified as a parameter value, this default value is handed over to the application.

It is to be noted that in each pair of an upper parameter attribute and a lower parameter attribute or each pair of an upper parameter and a lower parameter separated from each other by in the table TB23 in FIG. 10(C), the upper parameter attribute and the lower parameter attribute or the upper parameter and the lower parameter are alternative to each other (they have an OR relationship) i.e., only one of them can be specified, whereas an upper parameter attribute and a lower parameter attribute or an upper parameter and a lower parameter not separated from each other with “---” have an AND relationship and both of them must be specified, as in the table TB1 in FIG. 12.

The database unit 24 is a database having registered therein various types of information required for employee management and customer management.

For instance, if the communication system 10 operates within an intranet of a company, information indicating the name, the affiliated department, the telephone number, the mailing address, the electronic mail address, the ID and the like may be registered in the database unit 24 in correspondence to each of the employees of the company. The various types of information (such as the name) displayed in the next action selection page DC 12 are obtained by searching the database unit 24.

It is to be noted that although not shown in FIG. 1, the server apparatus 12, too, naturally includes a CPU and an OS equivalent to the control unit 14 in the client apparatus 11.

The transmission line PR 1 connecting the client apparatus 11 and the server apparatus 12 with each other may be a wired transmission line or a wireless transmission line, and it may even be a transmission line that includes both a wired block and a wireless block. In addition, the Internet or the like may be present in the middle of the transmission line PR1, or the transmission line may be a LAN (local area network) within a company without a WAN present.

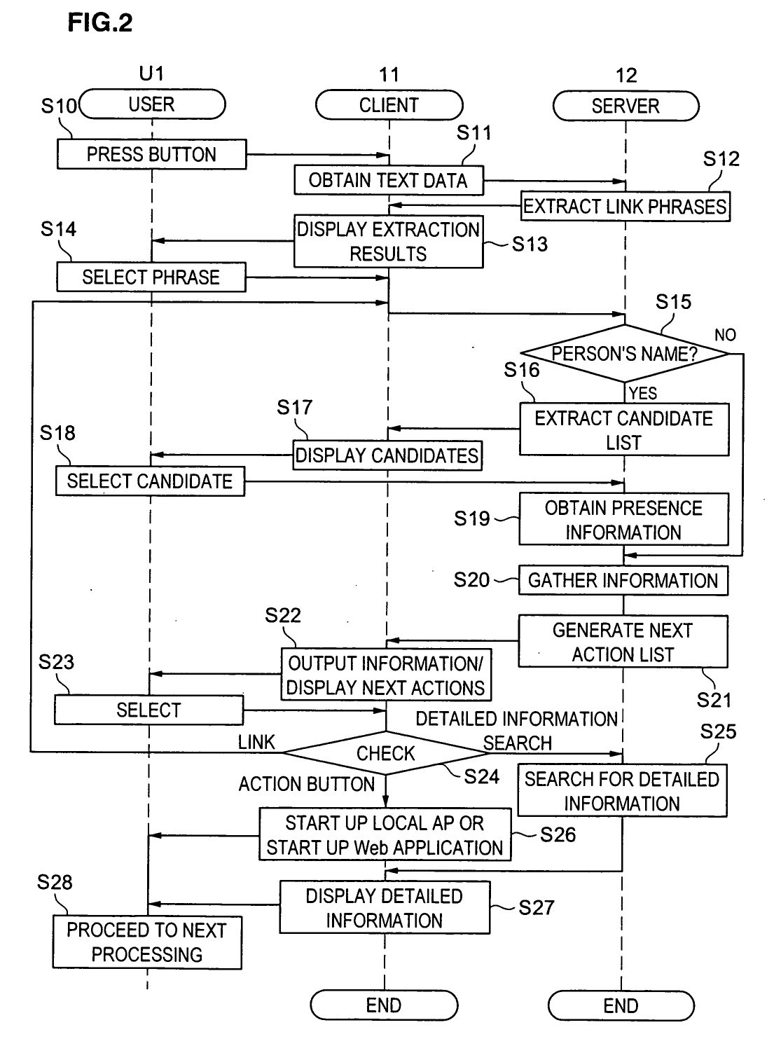

The following is an explanation of the operation executed in the embodiment adopting the structure described above, given in reference to the flowchart presented in FIG. 2.

The flowchart in FIG. 2 includes steps S10 through S28.

(A-2) Operation Executed in the Embodiment

The user U1 browsing a given document (web page) DC1 with the browser 13 in the client apparatus 11 issues an instruction to execute text data extraction processing on the document DC 1 by, for instance, clicking the phrase extraction button (S10).

Upon detecting the instruction, the text data extraction unit 15 in the client apparatus 11 extracts the text data from the document DC1 and transmits the extracted text data to the server apparatus 12 (S11). Upon receiving the extracted text data, the link phrase extraction unit 20 in the server apparatus 12 generates the keyword selection page DC 11 based upon the text data and sends the keyword selection page DC 11 thus generated back to the client apparatus 11 (S12). As described earlier, the keyword selection page DC 11 is a web page having one or a plurality of candidate keywords (link phrases) laid out in a click-enabling format. The candidate keywords may include proper nouns such as a person's name, a company name, a product name, a technology name and a telephone number as described earlier.

Upon receiving the keyword selection page DC 11, the link phrase display unit 16 in the client apparatus 11 has this keyword selection page DC 11 brought up on display by the browser 13 (S13).

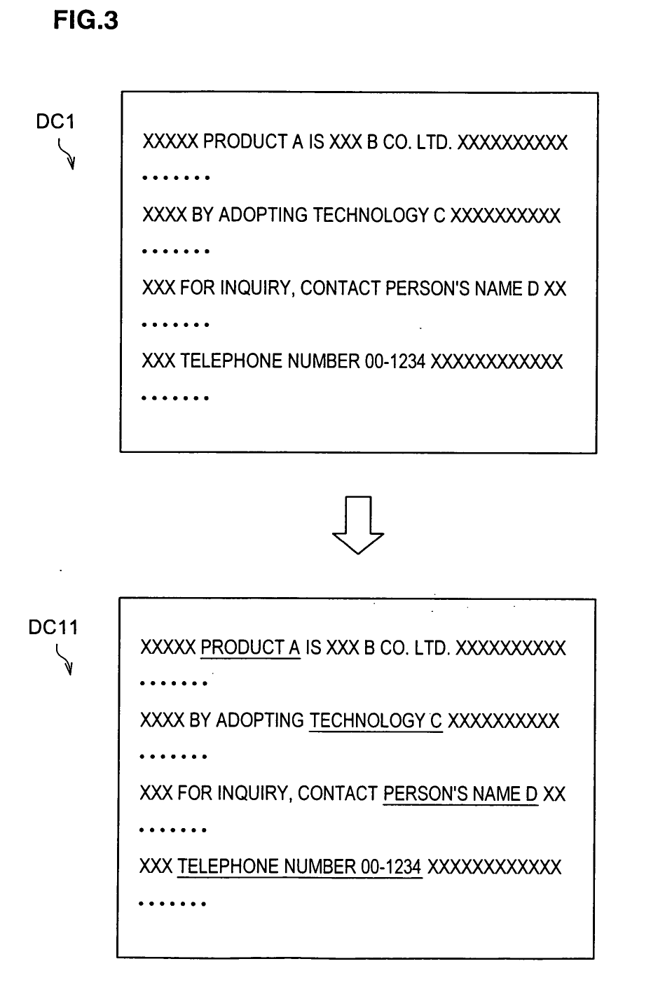

The screen may shift from the display of the document DC1 being browsed to by the user U1 in step S2 as described earlier to the display of the keyword selection page DC 11 in various ways, and FIGS. 3 to 6 present some examples of the screen shift.

In FIG. 3, the screen display in the browser 13 shifts as the entire document DC1 is replaced by the keyword selection page DC 11. In this case, screen displays with substantially identical contents are brought up for the user U1 in step S10 and step S13. However, character strings each constituting a candidate keyword may be marked with an underline or the display mode of the character strings that can be clicked may change as the mouse cursor is moved over the screen while the user reviews the screen in step S13 so as to distinguish those character strings as click-enabling candidate keywords.

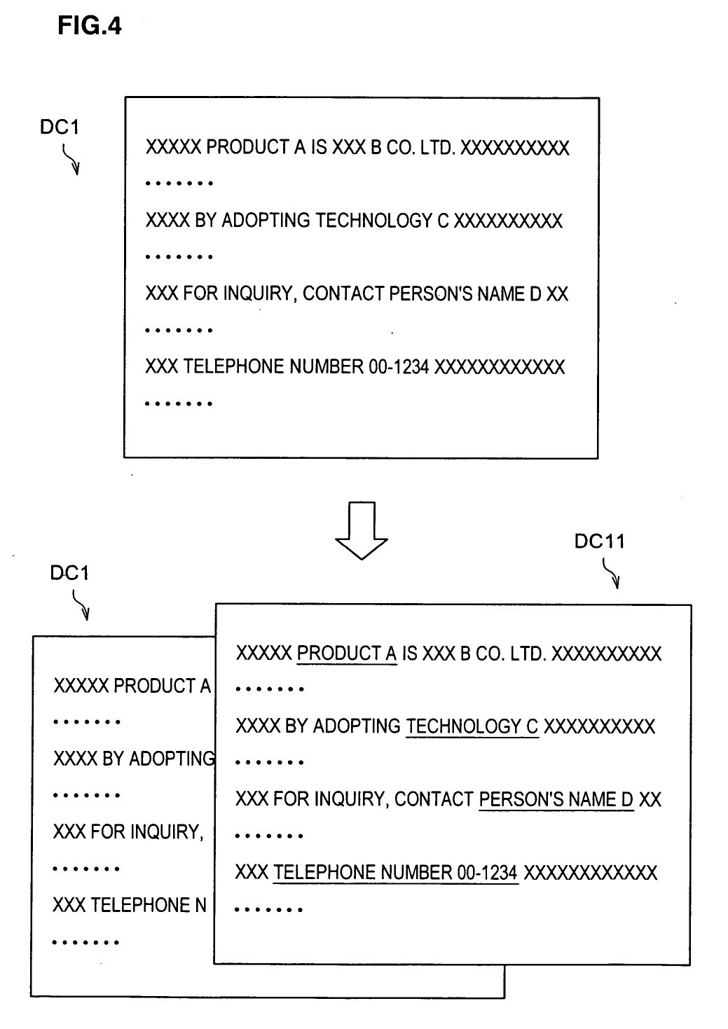

In the example presented in FIG. 4, the keyword selection page DC 11 is brought up on display in step S13 so as to overlap the display of the original document DC1. The contents of the keyword selection page DC11 are entirely identical to those of DC 11 in FIG. 3.

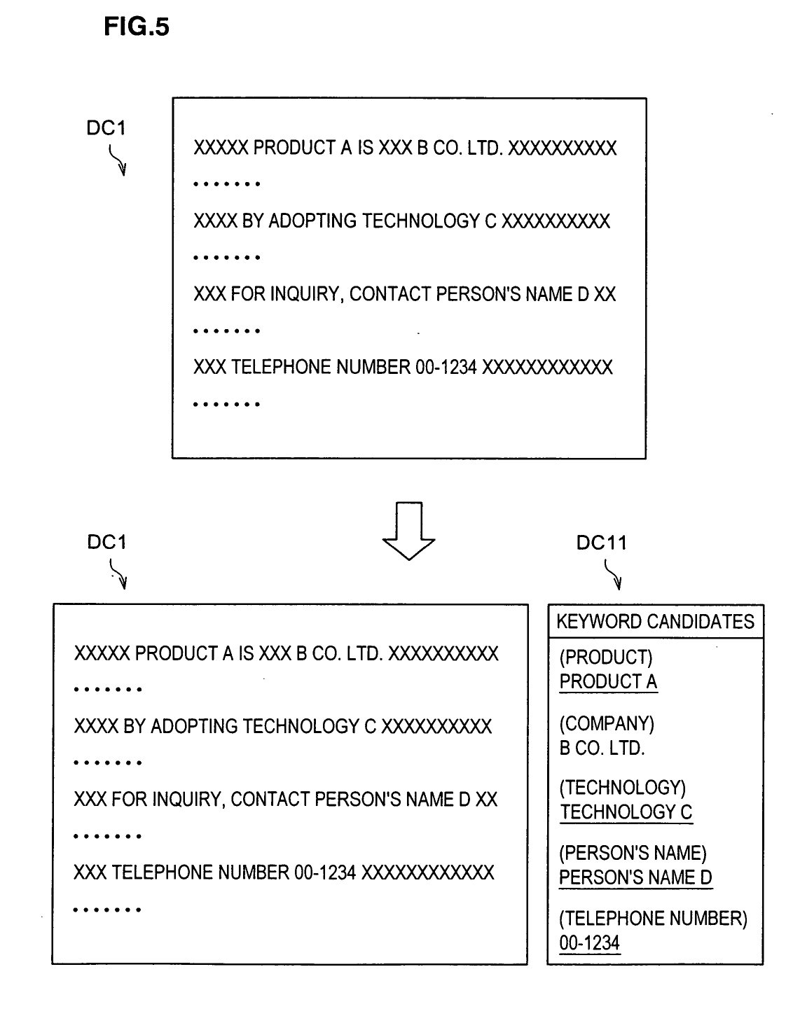

In the example presented in FIG. 5, the keyword selection page DC 11 is brought up on display in step S13 right next to the display of the original document DC 1. The keyword selection page DC 11 brought up on display in this example only lists the contents of the candidate keywords (which can be clicked) and the corresponding keyword attributes.

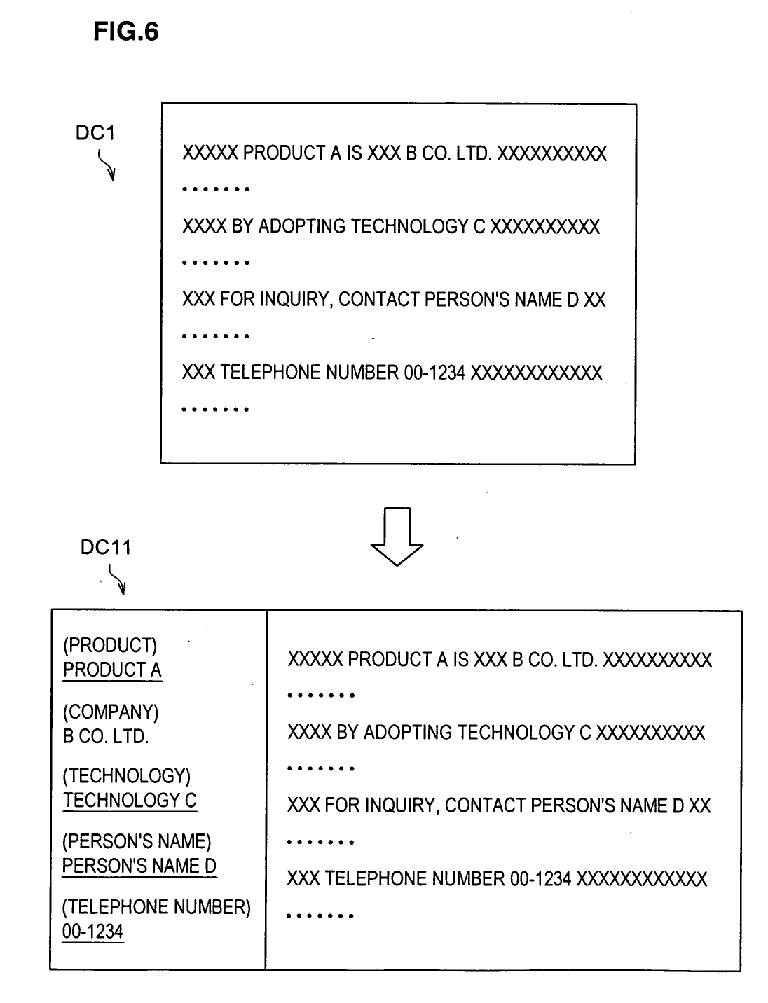

In the example presented in FIG. 6, the keyword selection page DC 11 is brought up on display in step S 13 as a web page created by using a frame mechanism. The frame mechanism is used to display a plurality of HTML files in a single web page and a frame page may be created by adopting any of various structures. In the example presented in FIG. 6, the small vertically elongated area at the left end contains a display similar to that of DC 11 in FIG. 5 with the contents of the original document DC1 displayed in the large area ranging from the center to the right end. While this page is up on display, the user U1 moves the mouse cursor over the small vertically elongated area at the left end and selects the desired keyword by clicking the candidate keyword.

It is to be noted that the screen brought up on display by the browser 13 through the subsequent processing (e.g. in step S17 or S22), too, shifts as shown in any of FIGS. 3 through 6.

The user U1 viewing the keyword selection page DC 11 with the browser 13 moves the mouse cursor to the desired phrase (candidate keyword) and clicks the phrase, thereby selecting the keyword (S14).

As the results of the selection are transmitted to the server apparatus 12, a decision is made in the server apparatus 12 as to whether or not the selected keyword is a person's name (S15). While the processing proceeds to step S20 to be detailed later if the selected keyword is not a person's name, the operation proceeds to step S16 if the keyword is a person's name.

In step S16, the candidate list extraction unit 21 generates the candidate list page DC 13 listing a plurality of candidates corresponding to the selected keyword (person's name) based upon the registered contents in the database unit 24 or the like (S 16), and then transmits the candidate list page DC 13 to the client apparatus 11. If IDs assigned to the individual employees are registered in the database unit 24, IDs used univocally within the company, too, can be obtained in addition to the affiliated departments and the full names of the candidates and, in such a case, the ID can be used as a keyword attribute of the person's name.

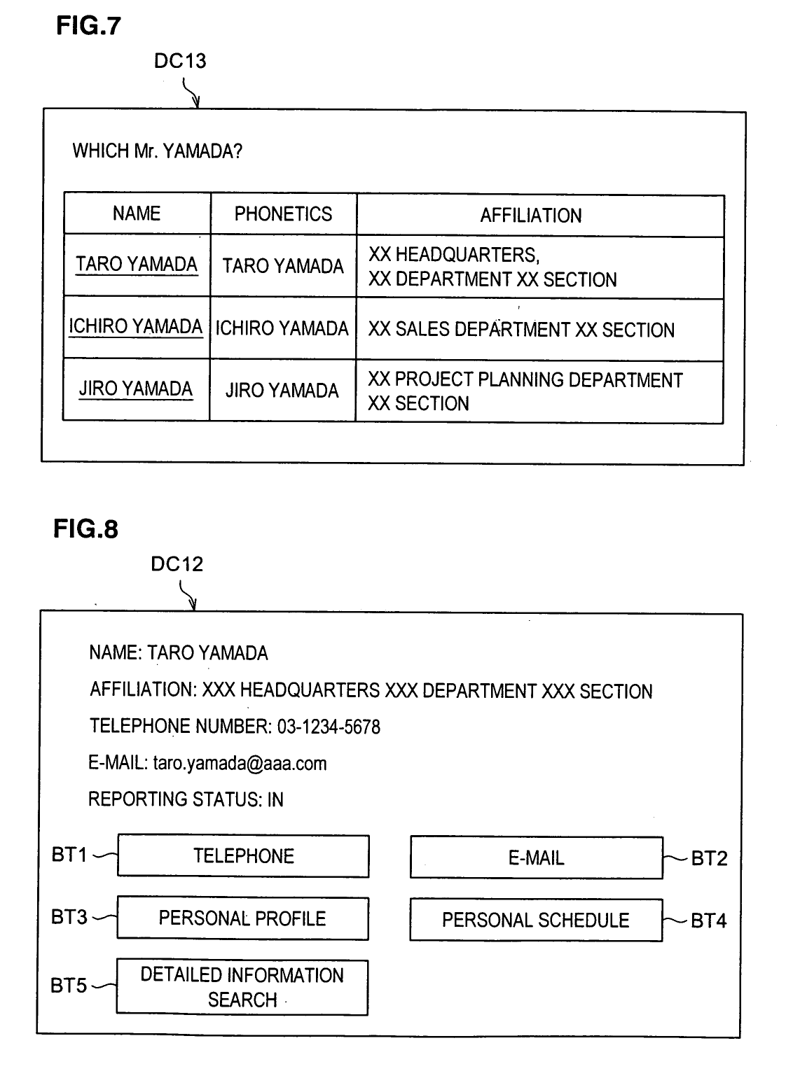

Upon receiving the candidate list page DC 13, the candidate list page DC 13 is brought up on display (S17) at the client apparatus 11. While any of various modes may be adopted with regard to the structure and the display contents of the candidate list page DC 13, a format such as that shown in FIG. 7 may be adopted.

In the example presented in FIG. 7, the user U1 has selected a candidate keyword constituted with a family name alone, i.e., “Yamada” in step S14, and accordingly, the full names, the phonetics and the affiliated departments with regard to a plurality of candidates, i.e., a plurality of persons with the family name Yamada, are displayed so as to help the user U1 univocally identify the correct Mr. Yamada. Since the full names of several different person's named Yamada can be clicked in the example presented in FIG. 7, the user U1 viewing the candidate list page DC 13 is able to indicate to the server apparatus 12 the right person by clicking the corresponding full name (S18).

If it becomes obvious by the time step S16 is executed that there is not a plurality of candidates and that a single person can be specified with the selected keyword, the processing in step S16 may be skipped and, in such a case, steps S17 and S18, too, can be skipped. However, an explanation is given here by assuming that the processing in steps S16 through 18 has been executed.

The server apparatus 12 having received the information indicating the candidate having been clicked (selected) in step S18 engages the presence ascertaining unit 22 to obtain the presence information related to the person (S19) and then engages the information extraction/organizing unit 23 in the information gathering process (S20). As explained earlier, the presence information may be obtained via the SIP server and the information gathering process may be executed by using a service provided in an intranet or on the Internet or by using the database unit 24, as explained earlier.

In step S21, which follows step S20, the information extraction/organizing unit 23 generates a next action information list and transmits the next action information list thus generated to the client apparatus 11 together with the results of the information gathering process. The next action list may be created through the following procedure.

Namely, the information extraction/organizing unit 23 may search the table TB 22 in FIG. 10(B) by using the attribute of the specified keyword as a search key and thus obtain the values of one or a plurality of next action attributes that are relevant. Next, by using the values corresponding to the next action attributes, it may search the table 23 in FIG. 10(C) to ascertain the value (URL) and the parameter of the corresponding application. If the values of a plurality of next action attributes are obtained by searching the table TB 22, the search of the table TB 22 is repeatedly executed by using each value as a search key.

The action attribute values obtained through the search of the table TB 22 shown in FIG. 10(B) each correspond to one of the character strings displayed on the buttons BT1 to BT5 in FIG. 8, as explained earlier.

Upon receiving the next action list, the client apparatus 11 brings up on display the next action selection page DC 12 such as that shown in FIG. 8 (S22). The next action selection page DC 12 in FIG. 8 is a next action list selection page that is brought up on display when the user U1 clicks (selects) “Taro Yamada” in the candidate list selection page DC 13 in FIG. 7 displayed by the browser 13. While information displayed in the next action selection page DC 12 (e.g., the affiliated department, the telephone number, etc., of Mr. Taro Yamada) is equivalent to the results of the search executed in response to the click (equivalent to a search key word entry) performed by the user U1 in step S14, candidates of actions that may be performed by the user U1 next are also displayed on the next action selection page DC 12 based upon the results of the search in addition to the information.

In step S23, the user U1 selects a desired action from the candidate actions by using the corresponding dialog component on the next action selection page DC 12. After checking the contents of the selection in step S24, the operation proceeds to one of three primary branches based upon the results of the check. If the user U1 has clicked a link such as “XXX Headquarters” or “XXX Department” in the next action selection page DC 12, the client apparatus 11 transmits a corresponding request message to the server apparatus 12 and then the operation returns to step S15.

If the user U1 has clicked one of the action buttons BT1 to BT4 and the button (e.g., BT1) corresponds to an application (e.g., a software phone (equivalent to a telephone)) installed in the client apparatus 11, the application is started up in the client apparatus 11 and the value of the relevant parameter (e.g., the telephone number of Mr. Taro Yamada) is handed over to the application at the time of the startup or immediately after the startup in step S26. If, on the other hand, the button having been clicked by the user U1 corresponds to an application (a web application) that is not installed in the client apparatus 11, the value of the relevant parameter (e.g., the full name of Mr. Taro Yamada) is attached to the request message transmitted to request a start up of the web application. With the parameter value handed over to the application in this manner, the user U1 does not need to perform a further input operation or click operation.

Regardless of whether the application to be started up is a local application or a web application, a specific value corresponding to the output information attribute having the same attribute name as that of the parameter attribute is handed over to the application being started up as a parameter value. The next action selection page DC 12 may contain such output information attributes and specific values in any of various formats. For instance, once it is ascertained that the attribute name of the parameter attribute of the parameter to be handed over to the software phone is “telephone number”, the AP startup-processing unit 18 is able to detect “03-1234-5678” in the next action selection page DC 12 in FIG. 8 as the specific value corresponding to the attribute name “telephone number” of the output information attribute matching the parameter attribute name “telephone number” and then to hand over the parameter value to the software phone by substituting “03-1234-5678” for the parameter “number” (see FIG. 12).

Since the specific value of the output information attribute is entered as the parameter corresponding to the parameter attribute based upon the correlation between the output information attribute and the parameter attribute, the user U1 only needs to click a button (e.g., BT1) to start up the application and hand over the parameter value by having the command (corresponds to the application) having been called up, the parameter and the parameter value (specific value) processed correctly in response to the click.

If no specific value corresponding to the output information attribute with the same attribute name as that of the parameter attribute is contained in the next action selection page DC 12, the default value in the application definition table TB 1 in FIG. 12 can be used as the parameter value.

While any of various methods may be adopted when making a decision as to whether the button having been clicked by the user U1 among the buttons BT1 to BT5 corresponds to a local application installed in the client apparatus 11 or a web application, the AP startup-processing unit 18 and the like may determine that the button corresponds to a local application if no URL is correlated to the button.

If it is decided that a local application is to be started up, the AP startup-processing unit 18 in the client apparatus 11 conducts a search of the application definition table TB 1 in FIG. 12 by using the value of the next action attribute (e.g., # telephone) correlated to the button (e.g., TB1) as a search key in the next action selection page DC 12 to obtain the correct path name (e.g., ¥ Program Files ¥ IPTelephone ¥ IPTelephone exe). As a result, the AP startup-processing unit 18 is able to ascertain the location of the application.

It is to be noted that the web application mentioned earlier may be installed in the server apparatus 12 or may be installed in any web server other than the server apparatus 12 as explained earlier.

In addition, while the processing for handing over the parameter value to the application being started up is, in principle, automatically executed without requiring the user U1 to enter the parameter value, in the embodiment, there may be a parameter, the value of which cannot be determined simply based upon the keyword or the specified action. In the case of such a parameter, the parameter value may be entered by the user U1 in an entry field provided in, for instance, the next action selection page DC 12 in FIG. 8.

For instance, the user U1, who has clicked the button BT4 wishing to learn Mr. Taro Yamada's schedule, will need to enter clear information indicating the specific time frame of the schedule the user U1 wishes to obtain, e.g., whether he wishes to know Mr. Yamada's schedule for today or for the next seven days, since such a time frame cannot be determined through processing executed by the server apparatus 12 or the like. The same principle applies to the map-scaling factor and the like mentioned earlier.

If the user U1 clicks the button BT5 in step S23 to issue an instruction for a detailed information search, the corresponding request message (containing the keyword (e.g., “Yamada” or “XXX headquarters”) and the keyword attribute (e.g., “person's name” or “organization name”)) is transmitted to the server apparatus 12, and the information extraction/organizing unit 23 at the server apparatus 12 searches for the detailed information in response (S25). As the search results are transmitted to the client apparatus 11, the detailed information, i.e., the search results, is displayed by the browser 13 or the like at the client apparatus 11 (S27), thereby making the desired detailed information available to the user U1. It is to be noted that the detailed information search may be executed in step S25 by adopting the technology disclosed in patent reference literature 1, as in the case of the information gathering process explained earlier.

Similar processing can be repeatedly executed on any documents other than the document DC1 as many times as necessary (S28).

If a screen display is brought up in the browser 13 through the application processing executed in step S26 or if the document brought up on display in step S27 contains character strings, text data can be extracted from the document on display by executing step S10 as described earlier and then the processing in steps S11 to S28 can be repeatedly executed.

Through the operation described above, the results of the search related to the phrase (keyword) selected in step S14 are made available to the user U1 through the display in the next action selection page DC 12 and furthermore, the next action selection page DC 12 includes candidate actions (the buttons BT1 to BT5) that the user U1 is likely to wish to take based upon the search results. As a result, the user U1 is able to take the desired action simply by clicking one of the buttons BT1 to BT5 without having to perform an operation for starting up a new application or an operation for handing the parameter value over to the application.

It is to be noted that although not included in the explanation given in reference to the flowchart presented in FIG. 2, a TCP/IP module or the like included in the OS is naturally utilized under normal circumstances each time communication is executed between communication devices via a network, e.g., each time the client apparatus 11 and the server apparatus 12 engage in communication with each other.

(A-3) Advantages Achieved in the Embodiment

In the embodiment, the page indicating the search results also includes buttons (BT1 to BT5) corresponding to candidates (options) of the actions that the user (U1) is likely to wish to take next based upon the search results. Thus, the user only needs to click one of the buttons to start up the desired application, which helps the user save operating time, reduces the operating cost and improves the work efficiency.

In addition, since the correct parameter value is handed over to the application at the time of the startup, the concern for erroneous parameter value entry can be eliminated to further improve the work efficiency by adopting the embodiment.

Furthermore, the embodiment, which allows direct utilization of the existing local applications installed in the client apparatus (11) and the existing web applications, e.g., an electronic mail application, a web application and a document and business applications handled with document preparation tools, without requiring any modifications, achieves a high level of viability.

Thus, the service level can be improved over the related art at low cost, and the user is allowed to continuously use familiar applications.

Moreover, since the correlation between the keyword attributes and the specific actions is defined in the action definition tables (TB 21 to TB 23) shown in FIGS. 10 (A) to 10(C) respectively, the next action options (candidates) corresponding to the keyword attributes can be displayed with ease in the next action selection page (DC 12).

### (B) Other Embodiments

While the embodiment described above includes a single client apparatus 11, it goes without saying that a plurality of client apparatuses may exist within the communication system 10.

In addition, the individual web pages may adopt structures other than those shown in, for instance, FIGS. 7 and 8 in reference to which the embodiment has been explained.

While the user U1 basically clicks an option he wishes to select in the screen displayed by the browser 13 in the embodiment, the browser 13 may be linked with any application having a function of handling documents on the client apparatus 11.

With such linkage in place, if the user performs a click operation or the like in a screen containing a document displayed by a given application, for instance, the text data can be extracted from the document and then the extracted text data can be transmitted to the server apparatus 12 via the browser 13. While it is desirable to display a button to be clicked to issue an instruction for text data extraction and a pulldown menu (equivalent to the phrase extraction button) in the screen brought up on display by the application, a macro or the like may be utilized if necessary.

The processing in the flowchart in FIG. 2 executed in the embodiment may be modified.

For instance, step S 19 may be executed between the yes side branch from step S15 and step S16. In such a case, the presence information corresponding to each candidate can be displayed in the candidate list page DC 13. This operational flow is particularly effective when the user U1 is not necessarily searching for a fixed subject and wishes to select a most suitable person by taking into consideration the presence information corresponding to the individual candidates.

If a very few candidates are extracted through the candidate list extraction processing in step S16, a single page displaying the buttons BT1 to BT5 as well as the information indicating the full names, the affiliated departments, the telephone numbers and the like of all the candidates may be transmitted to the client apparatus 11. In this case, the user U1 can perform the operation for selecting the desired person among the candidates and the operation for specifying the next action all at once in the single page, and thus, the operations in steps S18 and S23 can be integrated.

While the individual web pages (e.g., the next action selection page DC 12) are generated at the server apparatus 12 in the embodiment described above, the server apparatus 12 may provide the client apparatus 11 with necessary information so as to enable the client apparatus 11 to generate web pages, instead.

It is to be noted that while the functions that are needed to realize the present invention are distributed in the client apparatus 11 and the server apparatus 12 in the embodiment, the functions may be distributed in a manner different from that shown in FIG. 1.

For instance, if rigorous system management is implemented on each client apparatus (e.g., 11), the application definition table unit 19 may be mounted at the server apparatus 12, as explained earlier.

It is also possible to equip the client apparatus 11 alone with all the functions (or most of the functions) required to realize the present invention or to equip the server apparatus 12 alone with the functions necessary to realize the invention.

If all the functions necessary to realize the present invention are provided in the client apparatus 11, it is not strictly necessary to execute communication via a network.

It is to be noted that the present invention may be adopted when handling pages (documents) created by using a markup language other than HTML, as well.

Moreover, the communication protocol used for the communication achieved via a network according to the present invention does not need to be TCP/IP.

Most of the functions realized in hardware in the explanation provided above may instead be achieved in software, and almost all the functions realized in software in the explanation provided above may instead be achieved in hardware, as well.

What is claimed is:

1. An information-processing system that enables a user to start up a plurality of types of application function units each having one or a plurality of functions to allow a user to achieve specific purposes, comprising:
a phrase category-processing unit that extracts one or a plurality of phrases from a target document in response to an instruction issued by the user, identifies a specific phrase category of each extracted phrase and then correlates the phrase with the phrase category;
a first hypertext document-generating unit that generates a first hypertext document having a link attached to each phrase based upon said correlation between the phrase and the phrase category;
a first correlation management unit that manages a correlation between the phrase category and a single action category of an action or a plurality of action categories of actions to be taken by the user in correspondence to the phrase category;
a second correlation management unit that manages a correlation between the single action category or the plurality of action categories and locations of said application function units; and
a selection accepting unit that generates a second hypertext document having a single dialogue component or a plurality of dialogue components listed corresponding to the single action category or the plurality of action categories each listed as a link connection of a link assigned to a phrase in said first hypertext document provides the user with said second hypertext document and accepts an action selection made by the user, wherein:
when the user specifies a phrase in said first hypertext document, said first correlation management unit is engaged to search for action categories corresponding to the phrase category of the phrase and when the user selects a specific action by selecting a dialog component in said second hypertext document provided by said selection accepting unit, an application function unit corresponding to the action category of the action is started up by engaging said second correlation to search for the location of said application function unit.

2. An information-processing system according to claim 1, wherein:
when starting up said application function unit, a value of a parameter to be used in said application function unit is handed over to said application function unit.

3. An information-processing system according to claim 1, wherein:
if said application function unit is a web application, a request message transmitted to request a startup of said web application contains a value of a parameter to be used by said web application.

4. An information-processing system according to claim 1, wherein:
said first hypertext document is displayed so as to overlap the target document on display.

5. An information-processing system according to claim 1, wherein:
said first hypertext document lists the phrases and the phrase categories alone.

6. An information-processing system according to claim 1, wherein:
the target document and said first hypertext document are displayed as a web page generated by using a frame mechanism.

7. An information-processing method that allows a plurality of types of application function units to be started up, with each application function unit having one or a plurality of functions to enable a user to achieve specific purposes, having;
a phrase category processing unit extract one or a plurality of phrases from a target document in response to an instruction issued by the user, identify a specific phrase category of each extracted phrase and then correlate the phrase with a phrase category;
a first hypertext document-generating unit generate a first hypertext document having a link attached to each phrase based upon said correlation between the phrase and a phrase category;
a first correlation management unit manage a correlation between the phrase category and a single action category of an action or a plurality of action categories of actions to be taken by the user in correspondence to the phrase category;
a second correlation management unit manage a correlation between the single action category or the plurality of action categories and the locations of said application function units; and
a selection accepting unit generate a second hypertext document having a single dialogue component or a plurality of dialogue components corresponding to the single action category or the plurality of action categories each listed as a link connection of a link assigned to a phrase in said first hypertext document, provide the user with a second hypertext document and accepts an action selection made by the user, wherein:
when the user specifies a phrase in said first hypertext document, said first correlation management unit is engaged to search for action categories corresponding to the phrase category of the phrase and when the user selects a specific action by selecting a dialog component in said second hypertext document provided by said selection accepting unit, an application function unit corresponding to the action category of the action is started up by engaging said second correlation management unit to search for said location of said application function unit.

8. An information-processing method according to claim 7, wherein:
when starting up said application function unit, a value of a parameter to be used in said application function unit is handed over to said application function unit.

9. An information-processing method according to claim 7, wherein:
if said application function unit is a web application, a request message transmitted to request a startup of said web application contains a value of a parameter to be used by said web application.

10. An information-processing method according to claim 7, wherein:
said first hypertext document is displayed so as to overlap the target document on display.

11. An information-processing method according to claim 7, wherein:
said first hypertext document lists the phrases and the phrase categories alone.

12. An information-processing method according to claim 7, wherein:
the target document and said first hypertext document are displayed as a web page generated by using a frame mechanism.

13. An information-processing program that allows a plurality of types of application function groups to be started up with each application function group having one or a plurality of functions to enable a user to achieve specific purposes, realizing in a computer:
a phrase category processing function for extracting one or a plurality of phrases from a target document in response to an instruction issued by the user, identifying a phrase category of each extracted phrase and correlating the phrase with the phrase category;
a first hypertext document generating function for generating a first hypertext document having a link assigned to each phrase based upon said correlation between the phrase and the phrase category;
a first correlation management function for managing a correlation between the phrase category and a single action category of an action or a plurality of action categories of actions to be taken by the user in correspondence to the phrase category;
a second correlation management function for managing a correlation between said single action category or a plurality of action categories and the locations of the relevant application function groups; and
a selection accepting function for generating a second hypertext document having single dialogue component or a plurality of dialogue components in correspondence to said single action category or a plurality of action categories each listed as a link connection of a link assigned to a phrase in said first hypertext document, providing the user with said second hypertext document and accepting an action selection made by the user, wherein:
when the user specifies a phrase in said first hypertext document, said first correlation management function is engaged to search for action categories corresponding to the phrase category of the phrase and when the user selects a specific action by selecting a dialog component in said second hypertext document provided through said selection accepting function, an application function group corresponding to the action category of the action is started up by engaging said second correlation management function to search for said location of said application function group.

14. An information processing program according to claim 13, wherein:
when starting up said application function unit, a value of a parameter to be used in said application function unit is handed over to said application function unit.

15. An information processing program according to claim 13, wherein:
if said application function unit is a web application, a request message transmitted to request a startup of said web application contains a value of a parameter to be used by said web application.

16. An information processing program according to claim 13, wherein:
said first hypertext document is displayed so as to overlap the target document on display.

17. An information processing program according to claim 13, wherein:
said first hypertext document lists the phrases and the phrase categories alone.

18. An information processing program according to claim 13, wherein:
the target document and said first hypertext document are displayed as a web page generated by using a frame mechanism.
